(19) United States
(12) Patent Application Publication
(10) Pub. No.: US 2015/0368494 A1
(43) Pub. Date: Dec. 24, 2015

(54) ELECTRICALLY CONDUCTIVE INK COMPOSITION AND METHOD OF PREPARATION THEREOF

(71) Applicant: AGENCY FOR SCIENCE, TECHNOLOGY AND RESEARCH, Singapore (SG)

(72) Inventors: Jie ZHANG, Singapore (SG); Kok Leong CHANG, Singapore (SG); Jingjing CHANG, Singapore (SG); Weng Yew LEE, Singapore (SG); Jishan WU, Singapore (SG)

(21) Appl. No.: 14/764,977

(22) PCT Filed: Jan. 30, 2014
(86) PCT No.: PCT/SG2014/000041

§ 371 Date: Jul. 30, 2015

(30) Foreign Application Priority Data
Jan. 31, 2013 (SG) 201300781-0

(51) Int. Cl. C09D 11/52; H01B 1/02

(52) U.S. Cl. CPC C09D 11/52; H01B 1/023; H01B 1/026; H01B 1/02

(57) ABSTRACT

Method of preparing an electrically conductive ink composition is provided. The method includes providing one or more electrically conductive particles; contacting each of the one or more electrically conductive particles with a surface modifying agent and forming a layer of the surface modifying agent on each of the one or more electrically conductive particles by self-assembly. An electrically conductive ink composition, and use of the electrically conductive ink are also provided.

### CROSS-REFERENCE TO RELATED APPLICATION

This application claims the benefit of priority of Singapore patent application no. 201300781-0 filed on 31 Jan. 2013, the content of which is incorporated herein by reference in its entirety for all purposes.

### TECHNICAL FIELD

The invention relates to electrically conductive ink compositions, and methods of their preparation.

### BACKGROUND

Printed electronics refer generally to a manufacturing technology in which electrical devices are fabricated using common printing equipment and/or printing methods, such as screen printing and inkjet printing. Using electrically conductive inks and/or optical inks, active or passive electronic devices, such as thin film transistors or resistors, may be prepared on various substrates.

A major benefit to printed electronics technology is its low-cost volume fabrication, which allows fabrication of mass market items such as smart labels and flexible displays having cost and performance levels that are able to meet customer requirements.

Challenges facing printed electronics include 1) controlling structural orientation of organic semiconductors for improved device performance; 2) creating ohmic contact between semiconductor and electrode, of devices, such as printed field effect transistors (PFET), for improved device mobility; 3) obtaining high yield and repeatability of printed electronics; and 4) printability for in-line high, throughput roll-to-roll, roll-to-plate, and plate-to-plate printing.

Semiconductor structure and its orientation after deposition determine speed and quantity of electron/hole transport through the semiconductor, which in turn affects device mobility. Ability of an organic semiconductor to form ordered structure is determined by the organic semiconductor structure design, process condition, and interface characteristics of adjacent materials. The device mobility for a given semiconductor may range from O(10⁻³) to O(1), depending on organic molecule orientation and crystal/repeated unit size.

Contact resistance between semiconductor and electrode is influenced by work function of the electrode and highest occupied molecular orbital (HOMO)/lowest unoccupied molecular orbital (LUMO) of the semiconductor. In case of a p-type PFET, the contact resistance is directly proportional to mismatch of the work function of the electrode and the HOMO of the semiconductor. In other words, the higher the mismatch between the work function of the electrode and the HOMO of the semiconductor, the higher the injection barrier, thus contact resistance, is. Silver (Ag) ink and 6,13-bis(triisopropylsilylethynyl)pentacene (TIPS-Pentacene) are examples of electrode and semiconductor materials for PFETs. Mismatch between work function of the electrode (about 4.7 eV) and HOMO of the semiconductor (about 5.1 eV) is about 0.4 eV. This Schottky barrier delays transistor turn-on and suppresses transistor on-current, thereby resulting in lower device mobility.

In conventional printed electronics manufacturing methods, surface modification of source/drain electrodes via vapor or solution phase treatment after their deposition on a substrate involves a long and tedious process, usually in the order of a few hours to more than 10 hours due to slow chemical reaction and functional group organization. This presents a bottleneck in the high-throughput roll-to-roll manufacturing of printed electronics, which have typical printing speeds of greater than 5 m/min. Furthermore, the extended solvent exposure weakens layer-to-layer adhesion on the printed structure. This may result in peel-off, and/or the printed electrode/dielectric may partially dissolve or react to result in low device yield. To make printed electronics feasible for application in industry, the long processing times and low product yields need to be addressed.

In view of the above, there exists a need for an improved method to prepare electrically conductive ink compositions that overcomes or at least alleviates some of the above-mentioned problems.

### SUMMARY

In a first aspect, the invention relates to method of preparing an electrically conductive ink composition. The method comprises
a) providing one or more electrically conductive particles;
b) contacting each of the one or more electrically conductive particles with a surface modifying agent and forming a layer of the surface modifying agent on each of the one or more electrically conductive particles by self-assembly.

In a second aspect, the invention relates to an electrically conductive ink composition prepared by a method according to the first aspect.

In a third aspect, the invention relates to an electrically conductive ink composition comprising one or more electrically conductive particles. Each of the one or more electrically conductive particles has a self-assembled layer of a surface modifying agent attached to its surface.

In a fourth aspect, the invention relates to use of an electrically conductive ink composition according to the second aspect or the third aspect in printed field effect transistors, printed diodes, printed electronics, printed circuits, organic light emitting displays, photovoltaics, printed memory, printed sensors, or printed intelligence.

### BRIEF DESCRIPTION OF THE DRAWINGS

The invention will be better understood with reference to the detailed description when considered in conjunction with the non-limiting examples and the accompanying drawings, in which:

FIG. 1 is a schematic diagram showing (A) printed electrodes printed using ink without surface functionalization; and (B) printed electrodes with self-assembled monolayer (SAM) functionalized on the conductive particles during ink formulation. In various embodiments, prior to printing source drain electrodes, selected SAM is introduced into the conductive ink chemistry. The SAM, therefore, attach to metal particles in ink before printing during ink shelving. The SAM treated conductive ink may be printed as normal conductive ink without further treatment after formation of the electrode. Advantageously, this allows the desired printing speed to be retained on a well balanced printing line.

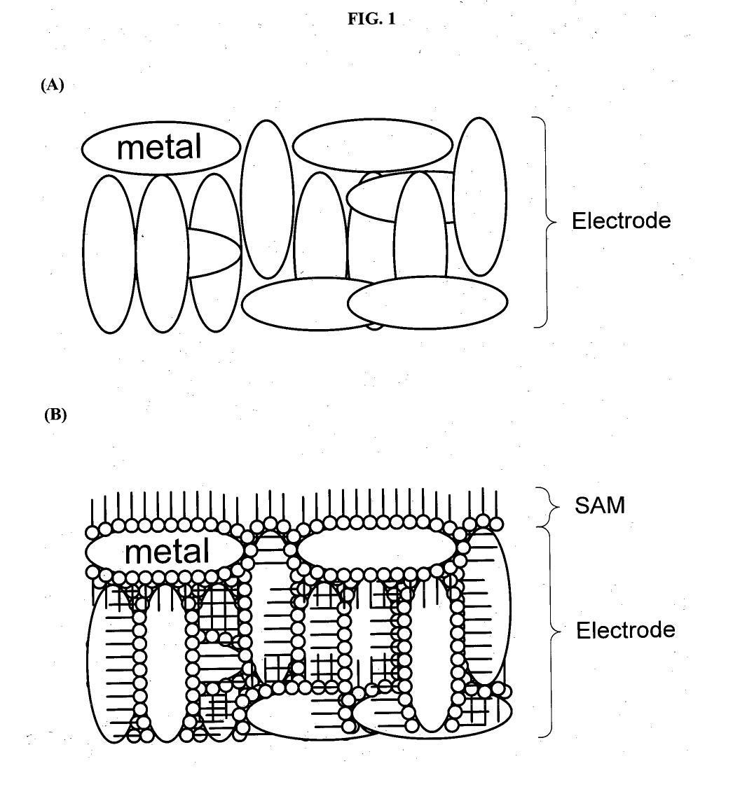

FIG. 2 is a schematic diagram showing illustration of SAM layer induced preferred edge-on orientation for TIPs pentacene, with focus on SAM and TIPs pentacene interaction at the interface.

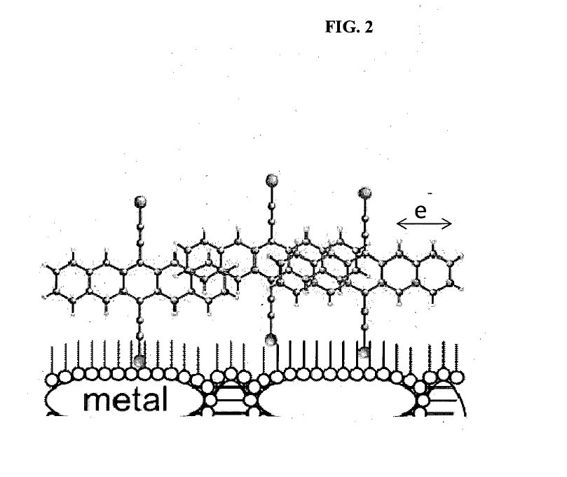

FIG. 3 depicts microscope images showing semiconductor orientation and stacking affected by electrode surface chemistry with an inset plot of drain current (A) v.s. gate voltage (V): (A) small crystals with many grain boundaries in PFET channel; and (B) poly-crystals across PFET channel of SAMs treated electrodes. Scale bar in the figures denote a length of 200 μm. For the inset plot in (A) and (B), y-axis denotes drain current (A) with tick marks ranging from 10⁻¹² to 10⁻⁴; x-axis denotes gate voltage (V) with tick marks ranging from −60 to 10.

FIG. 4 depicts graphs showing current-voltage (IV) characteristics for PFETs using (A) un-treated electrode; and (B) SAM treated electrode.

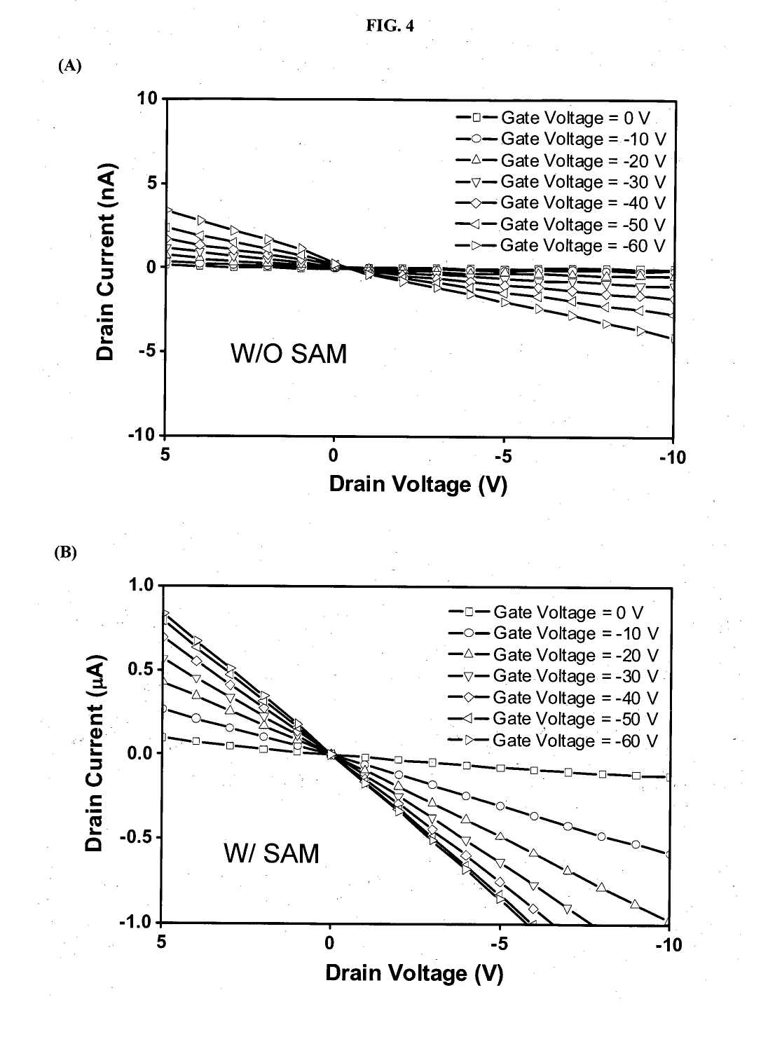

FIG. 5 is a microscope image showing defects created due to SAMs surface functionalization process for (A) dielectric, and (B) electrodes.

FIG. 6 is a graph showing measured I_{D}-V_{G} characteristics of PFETs with pristine and ink formulated electrodes.

FIG. 7 is a photograph showing a printing line. “n” denotes the number of additional stages that are required for SAM treatment assuming 1 m per minute printing speed on roll-to-roll printing press.

FIG. 8 shows structure of N-alkyl diketopyrrolo-pyrrole (DPP) based p-type semiconductor used in the experiments.

FIG. 9 depict graphs of measured I_{D}-V_{G} characteristics of PFETs based on the N-alkyl diketopyrrolo-pyrrole (DPP) semiconductor for (A) ink formulated electrodes and (B) pristine electrodes. FIG. 9(C) is a table showing mobility (cm²/V·s), Vt (V) and Iₒₙ/I_{off} values for printed Ag (Gate)/printed source/drain structure using DPP polymer semiconductor, and printed Ag as source/drain material (i) without modification, and (ii) Ag ink with SAM modification. Results summarized in the table of FIG. 9C shows that the printed organic field-effect transistor (OFET) devices using the innovative ink improved OFET mobility in two orders of magnitude, as compared to results generated from devices using pristine Ag ink.

### DETAILED DESCRIPTION

A surface modifying agent is introduced to an electrically conductive ink composition during ink preparation. In doing so, electrically conductive particles in the ink are modified before printing. This allows slow self-assembly of surface modifying agent on the electrically conductive particles to take place during ink preparation or ink shelving, and which may proceed to completion during the ink preparation or ink shelving prior to printing. Accordingly, high throughput printing processes may continue without being confined by the slow self-assembly processes of forming a self-assembled monolayer (SAM) of surface modifying agent on the printed electrodes. By creating electrode ink formulations with the required work function, electrode surface functionalization step in conventional methods is eliminated to result in improved process efficiency.

In addition to improvement in process efficiency, performance of electrodes formed using this SAMs-in-ink formulation is comparable to electrodes which are surface functionalized using state of the art methods. For example, functional groups on the surface modifying agent, which are formed as a layer on each electrically conductive particle, allow self-assembly of organic semiconductors to their preferred stacking and/or structure on the printed electrodes. Therefore, performance requirements of electrically conductive ink are maintained, while manufacturing process capabilities and yield of products using the electrically conductive ink composition are improved.

Accordingly, in a first aspect, the present invention relates to method of preparing an electrically conductive ink composition.

The term “electrically conductive ink composition” as used herein refers to a liquid or a liquid-like substance, such as gel and paste, containing electrically conductive particles dispersed or suspended therein. The particles are electrically conductive, meaning that the particles are able to allow an electric charge to flow through. The liquid or liquid-like substance containing the particles is electrically conductive, although the liquid or liquid-like substance containing the particles may or may not by itself be electrically conductive. In various embodiments, the particles are able to conduct electricity with minimal impedance to electrical flow.

The term “particle” as used herein refers to microstructures, nanostructures, and combinations thereof. The term “microstructures” refers to materials with at least one dimension in the micrometer range. The term “nanostructures” refers to materials with at least one dimension in the nanometer range.

In various embodiments, the electrically conductive particle is an electrically conductive microstructure. For example, the electrically conductive microstructure may be a microparticle, a microrod, and the like. The at least one dimension of the electrically conductive microstructure may be less than 100 μm, such as a length in the range from about 1 μm to about 100 μm, about 1 μm to about 80 μm, about 1 nm to about 60 μm, about 1 μm to about 40 μm, about 10 μm to about 100 μm, about 10 μm to about 80 μm, about 10 μm to about 60 μm, about 10 μm to about 40 μm, about 20 μm to about 80 μm, or about 30 μm to about 60 μm.

In various embodiments, the electrically conductive particle is an electrically conductive nanostructure. Examples of that may be used include nanoparticles, nanopowder, nanorods, nanowires, nanotubes, nanodiscs, nanoflowers, nanoflakes and nanofilms. In various embodiments, the one or more electrically conductive nanostructures are nanoparticles.

In various embodiments, at least one dimension of the electrically conductive nanostructure is less than 100 nm. For example, the at least one dimension of the electrically conductive nanostructure may have a length in the range of about 1 nm to about 100 nm, about 1 nm to about 80 nm, about 1 nm to about 60 nm, about 1 nm to about 40 nm, about 10 nm to about 100 nm, about 10 nm to about 80 nm, about 10 nm to about 60 nm, about 10 nm to about 40 nm, about 20 nm to about 80 nm, or about 30 nm to about 60 nm.

The one or more electrically conductive particles may be essentially monodisperse, whereby the term “monodisperse” refers to the particles of at least substantially the same size. As the particles may not be regular in shape and/or be of the same shape, the term “size” as used herein refers to the maximal dimension of the particles. In various embodiments, the maximal dimension of the particle is less than 100 nm.

The method comprises providing one or more electrically conductive particles. In various embodiments, the one or more electrically conductive particles comprises or consists of a metal. The one or more electrically conductive particles may comprise or consist of a metal selected from Group 3 to Group 13 of the Periodic Table of Elements, or combinations thereof. In various embodiments, the one or more electrically conductive particles comprises or consists of a metal selected from the goup consisting of silver, copper, gold, nickel, aluminum, or combinations thereof.

The method of the first aspect includes contacting each of the one or more electrically conductive particles with a surface modifying agent. As used herein, the term “surface modifying agent” refers to a compound or a moiety that alters the chemical nature of the electrically conductive particle surface. As mentioned above, the surface modifying agent includes compounds having functional groups that allow subsequent deposition of organic semiconductors, which may take place via self-assembly, to a preferred stacking and/or structure on electrodes which are printed using the electrically conductive ink composition disclosed herein.

For example, the surface modifying agent may include compounds having functional groups that allow self-assembly of organic semiconductors with preferred orientation and π-π stacking, thereby forming a high performance transistor.

In various embodiments, the surface modifying agent is selected from the group consisting of an organic thiol compound, an organic acid, and an organic charge-transfer compound.

For example, the organic thiol compound may be an optionally substituted C₄ to C₂₀ thiol compound, such as octanethiol, decanethiol, or dodecanethiol. The organic acid may be an optionally substituted C₄ to C₂₀ organic acid having phosphonic acid, sulphonic acid, and/or carboxylic acid functional groups.

Examples of organic acid having a phosphonic acid functional group include, but are not limited to, pentafluorobenzyl phosphonic acid, octadecylphosphonic acid, octylphosphonic acid, and mixtures thereof. Examples of organic acid having a sulphonic acid functional group include, but are not limited to, alkyl sulphonic acids such as methane sulfonic acid; aryl sulfonic acids such as p-toluene sulfonic acid, benzene sulfonic acid, and styrene sulfonic acid; and mixtures thereof. Examples of organic acid having a carboxylic acid functional group include, but are not limited to, benzoic acid, 4 methylbenzoic acid, octadecanoic acid, octylcarboxylic acid, 16-hydroxyhexadecanoic acid, 1,12-dodecandioic acid, 12-aminododecanoic acid, 12-bromododecanoic acid, and mixtures thereof.

The terms “organic charge-transfer compound” and “organic charge-transfer complex” are used interchangeably herein, and refer to an organic compound having two or more molecules or atoms with electrons exchange between the molecules or atoms. The organic charge-transfer compound may be one or more of a cyanoquinodimethane compound, hydrazone compound, a pyrene compound, a pyrazoline compound, an oxazole compound, a triarylmethane compound, or a arylamine compound.

In specific embodiments, the surface modifying agent is selected from the group consisting of pentafluorobenzyl thiol, 1-octanethiol, pentafluorobenzyl phosphonic acid, 1-octylphosphonic acid, benzoic acid, 4-methylbenzoic acid, tetracyanoquinodimethane, F4-tetracyanoquinodimethane, and mixtures thereof.

The surface modifying agent may be attached to a surface of each of the one or more electrically conductive particles, for example, by physical forces such as van der Waals forces, or chemical forces such as covalent bond. In various embodiments, the surface modifying agent is chemically bonded to a surface of each of the one or more electrically conductive particles. For example, the surface modifying agent may be attached to a surface of each of the one or more electrically conductive particles by covalent bonding.

Forming a layer of the surface modifying agent on each of the one or more electrically conductive particles takes place by self-assembly. The term “self-assembly” (SA) as used herein refers to processes in which a disordered system of pre-existing components forms an organized structure or pattern as a consequence of specific, local interactions among the components themselves, without external direction. It may be defined as the spontaneous and reversible organization of molecular units into ordered structures by non-covalent interactions.

In various embodiments, the surface modifying agent forms a self-assembled monolayer on the one or more electrically conductive particles, such that some of, at least a substantial portion of, or all of the surface area of each of the one or more electrically conductive particles that is exposed to the surface modifying agent is covered by the surface modifying agent.

Advantageously, by forming a self-assembled layer of surface modifying agent on each of the one or more electrically conductive particles, the electrically conductive ink so treated may be used in formation of printed electrodes, for example, without the need for further treatment after forming the printed electrodes. This allows the slow self-assembly process to be completed outside of a conventional roll-to-roll manufacturing process, thereby translating in improvements in process efficiency. As mentioned above, using a method of the first aspect, structure and/or orientation of organic semiconductors deposited on the printed electrodes, which is required for improved device performance, is improved. At the same time, contact resistance between semiconductor and electrode of devices is reduced without sacrificing manufacturability.

In a second aspect, the invention relates to an electrically conductive ink composition prepared by a method according to the first aspect. In a further aspect, the invention relates to an electrically conductive ink composition comprising one or more electrically conductive particles.

As mentioned above, the electrically conductive particles may include microstructures and/or nanostructures.

Examples of microstructures that may be used include, but are not limited to, microparticles and/or microrods, and the like. Examples of nanostructures that may be used include nanoparticles, nanopowder, nanorods, nanowires, nanotubes, nanodiscs, nanoflowers, nanoflakes and nanofilms. In various embodiments, the one or more electrically conductive particles are nanoparticles.

In various embodiments, the one or more electrically conductive particles comprises or consists of a metal. The one or more electrically conductive particles may comprise or consist of a metal selected from Group 3 to Group 13 of the Periodic Table of Elements, or combinations thereof. In various embodiments, the one or more electrically conductive particles comprises or consists of a metal selected from the group consisting of silver, copper, gold, nickel, aluminum, or combinations thereof.

Each of the one or more electrically conductive particles in the electrically conductive ink composition has a self-assembled layer of a surface modifying agent attached to its surface. Some of, at least a substantial portion of, or all of the surface of each of the one or more electrically conductive particles is covered by the surface modifying agent. The surface modifying agent may be chemically bonded to a surface of each of the one or more electrically conductive particles, for example, by covalent bonding.

As mentioned above, the surface modifying agent may be selected from the group consisting of an organic thiol compound, an organic acid, and an organic charge-transfer compound. Examples of organic thiol compounds, organic acids, and organic charge-transfer compounds have already been mentioned above. In specific embodiments, the surface modifying agent is selected from the group consisting of pentafluorobenzyl thiol, 1-octanethiol, pentafluorobenzyl phosphonic acid, 1-octylphosphonic acid, benzoic acid, 4 methylbenzoic acid, tetracyanoquinodimethane, F4-tetracyanoquinodimethane, and mixtures thereof.

The surface modifying agent may form a self-assembled monolayer on the one or more electrically conductive particles, such that some of, at least a substantial portion of; or all of the surface area of each electrically conductive particle is covered by the self-assembled monolayer.

The electrically conductive ink composition is capable of being applied to various substrates, for example, using common printing equipment and/or printing methods, such as screen printing and inkjet printing. Accordingly, in a fourth aspect, the invention relates to use of an electrically conductive ink composition according to the second aspect or the third aspect in printed field effect transistors, printed diodes, printed electronics, printed circuits, organic light emitting displays, photovoltaics, printed memory, printed sensors, or printed intelligence.

Hereinafter, the present invention will be described more fully with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, lengths and sizes of layers and regions may be exaggerated for clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The invention illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

### EXPERIMENTAL SECTION

As mentioned previously, challenges facing printed electronics include 1) controlling structure or orientation of organic semiconductors for improved device performance; 2) creating ohmic contact between semiconductor and electrode of devices, such as printed field effect transistors, for improved device mobility; 3) obtaining high yield and repeatability of printed electronics; and 4) printability for in-line high throughput roll-to-roll, roll-to-plate, and plate-to-plate printing.

### Example 1

### Printed Electronics Performance Vs. Organic Semiconductor Molecule Alignment

Regardless of traditional or printed electronics, semiconductor structure/orientation determines speed and quantity of electron/hole transport through the semiconductor in the form of device mobility. Ability of organic semiconductor to form ordered structure is determined by the organic semiconductor structure design, process condition, and interface characteristics of adjacent materials. For a given semiconductor, device mobility may range from O(10⁻³) to O(1), depending on organic molecule orientation and crystal size.

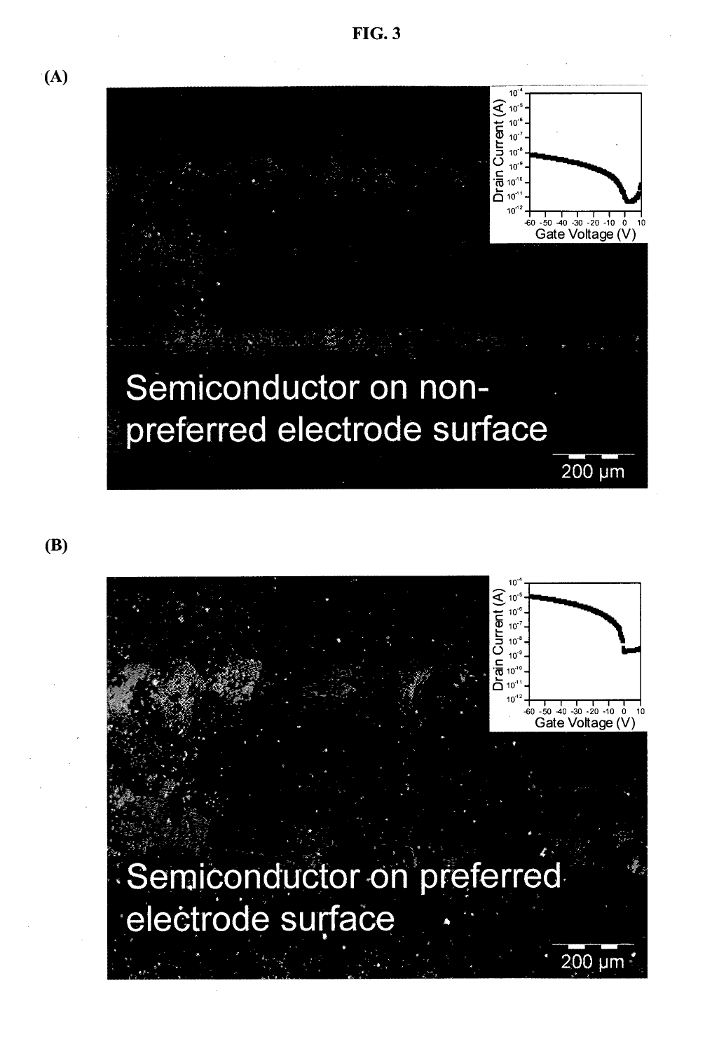

FIG. 3 depicts microscope images showing semiconductor orientation and stacking affected by electrode surface chemistry: (A) small crystals with many grain boundaries in PFET channel; and (B) poly-crystals across PFET channel of SAMs treated electrodes.

Without SAM on the electrode, such as that shown in FIG. 3A, the organic semiconductor formed small and randomly oriented crystals and multiple grains with many grain boundaries. This in turn results in low device mobility and large variation. With SAM on the electrode, such as that shown in FIG. 3B, large crystals (tens of micron) with preferred orientation were formed. This translates into high device mobility.

### Example 2

### Contact Resistance Between Semiconductor and Electrode

Contact resistance between the semiconductor and electrode is influenced by the work function of the electrode and the highest occupied molecular orbital (HOMO)/lowest unoccupied molecular orbital (LUMO) of the semiconductor. In the case of a p-type PFET, the contact resistance is directly proportional to the mismatch of the work function of the electrode and the HOMO of the semiconductor. In other words, the higher the mismatch between the work function of the electrode and the HOMO of the semiconductor, the higher the injection barrier is, thus a higher contact resistance.

Silver ink and TIPS-Pentacene are examples of electrode and semiconductor materials for PFETs. Mismatch between the work function of the electrode (about 4.7 eV) and the HOMO of the semiconductor (about 5.1 eV) is about 0.4 eV. This Schottky barrier delays transistor turn-on and suppresses transistor on-current, resulting in lower device mobility.

### Example 3

### Low Device Yield Due to Extended Wet Chemical Process for SAMs on Electrodes

To form a self-assembled monolayer on printed electrode, a prolonged wet chemical treatment may be used. It generally takes a few hours to over 10 hours due to slow reaction of thiols and metal electrodes. This extended exposure to solvent weakens layer-to-layer adhesion on the printed structure, resulting in peel off of the layers. The structural damages on printed structures lead to very low yield on printed transistor/circuits.

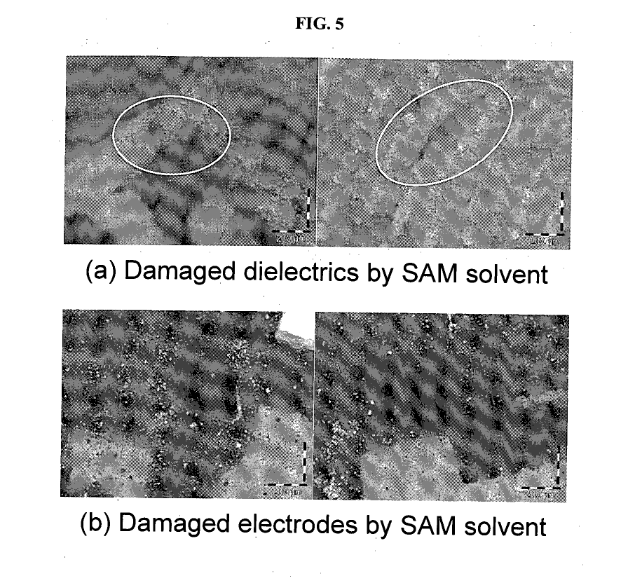

FIG. 5 depicts microscope images showing defects created due to SAMs surface functionalization process for (A) dielectric, and (B) electrodes.

To make printed electronics feasible for industry applications, the long process time and low yield need to be addressed.

### Example 4

### Manufacturing Bottleneck Created by the Slow SAMs Formation Process

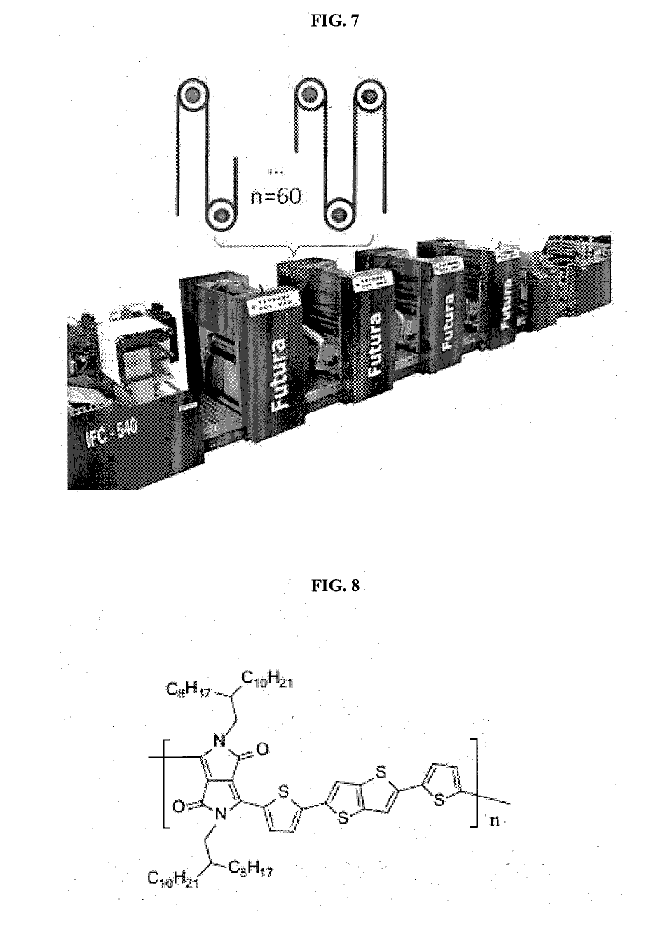

FIG. 7 is a photograph showing a printing line. “n” denotes the number of additional stages that are required for SAM treatment assuming 1 m per minute printing speed on roll-to-roll printing press.

As mentioned above, self-assembly process is a slow chemical reaction process requiring long hours of wet chemical treatment in vapor and/or liquid phases. This creates extreme problem for in-line manufacturing. Assuming that the printing line is maintained at a speed of 5 m/min, 1 hour of chemical treatment would require a 60 meter long chemical bath, and so on. This is impractical for in-line high throughput manufacturing that printed electronics is motivated by.

### Example 5

### Comparison of Performance of Pristine and Ink Formulated Electrodes Using Small Molecule Semiconductor

In view of the above discussion, it may be seen that methods disclosed herein allow one or more of 1) controlled organic semiconductor orientation and stacking for high device mobility; 2) ensuring ohmic contact between the semiconductor and the electrode of a PFET for the result of improving device mobility; 3) high yield and repeatability of printed electronics; and 4) enabling in-line high throughput roll-to-roll, roll-to-plate, plate-to-plate printing ability.

The SAMs on the surface modifying agent help to tune work function on the metal electrode to better match semiconductor HOMO/LUMO level to reduce hole/electron injection barrier at metal/semiconductor interface.

TIPs pentacene was used in the experiments as an example of small molecule semiconductor. The characteristics of the pristine and ink formulated electrodes are presented in Table 1.

TABLE 1
Characteristics of pristine and ink formulated electrodes

| | Work function | Sheet Resistance | Device Mobility |
|---|---|---|---|
| Electrode | (eV) | (mΩ/□) | (cm²V⁻¹ s⁻¹) |
| Pristine | 4.63 | 27.85 | 2 × 10⁻⁴ |
| Ink formulated | 5.66 | 318.70 | 4 × 10⁻² |

The work function of the pristine electrode is 4.63 eV, which agrees with work function of silver. The work function of the ink formulated electrode is 5.66 eV. The work function of the ink formulated electrode is higher than the pristine Ag electrode which proves the presence of SAMs on the former.

The sheet resistance of the pristine electrode is about 30 mΩ/□, whereas the sheet resistance of the ink formulated electrode is about 300 mΩ/□ (about 10 times higher). The unit “mΩ/□” is defined as milliohms per square, which is a unit for evaluating sheet resistance for conductive films. The higher sheet resistance of the ink formulated electrode is due to the presence of SAMs between the conductive particles that increases the effective resistance of the electrode. Nevertheless, the 10 times increase in the resistance of the electrode post minimum performance effect on device performance because the resistance of the semiconductor is in the range of about 1 MΩ in transistor channel in between of source and drain electrodes. This argument is evident in the device mobility measurements. The device mobility of the ink formulated electrodes is about 2 orders higher than the pristine electrode.

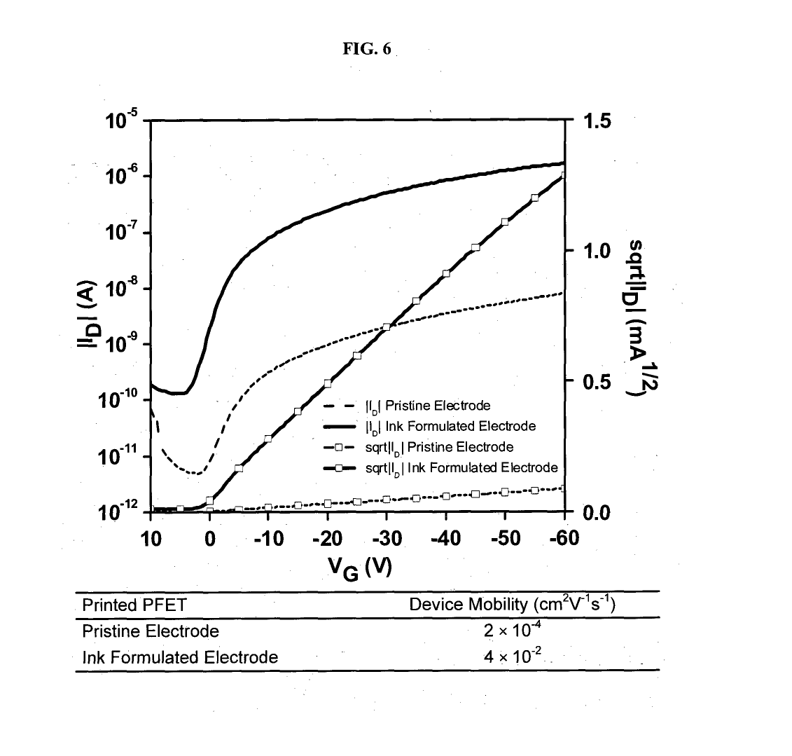

The I_{D}-V_{G} of the two approaches is depicted in FIG. 6. The ink formulated approach demonstrates an optimum trade-off for performance and roll-to-roll processability.

For printed electrodes, surface functionalization disclosed herein may be applied before formation of the electrode by ink formulation. As mentioned above, surface of electrically conductive particles in ink form are functionalized. This sets the method apart from state of the art methods, where surface functionalization either in vapor or solution phase involves wet chemistry which compromise and contaminates materials/stmctures that are formed before the electrode. Furthermore, in cases where vacuum deposition is used, it is not possible to apply surface functionalization before formation of electrodes.

For example, a bottom gate bottom contact transistor requires that the gate and dielectric be immersed together with the electrode. This usually compromises reliability of the gate and dielectric, as the gate and/or dielectric may be lifted from the substrate. The dielectric may incur high leakage currents as a result. Methods disclosed herein functionalize the electrode ink directly before printing, thereby removing the need for solution or vapor immersion. This translates into improved reliability and reduces cumbersome steps for printed electronics manufacturing.

Use of the SAM functionalized conductive ink is also preferred for top-contact printed transistor configuration, where semiconductor is printed before source/drain electrodes. This further justifies the bandgap/work function alignment at the interface between semiconductor and metal electrodes.

### Example 6

### Performance of SAM Modified Ag Ink Using Conjugated Polymer

The modified Ag ink was further evaluated using conjugated polymer, in addition to small molecule semiconductor TIPs pentacene.

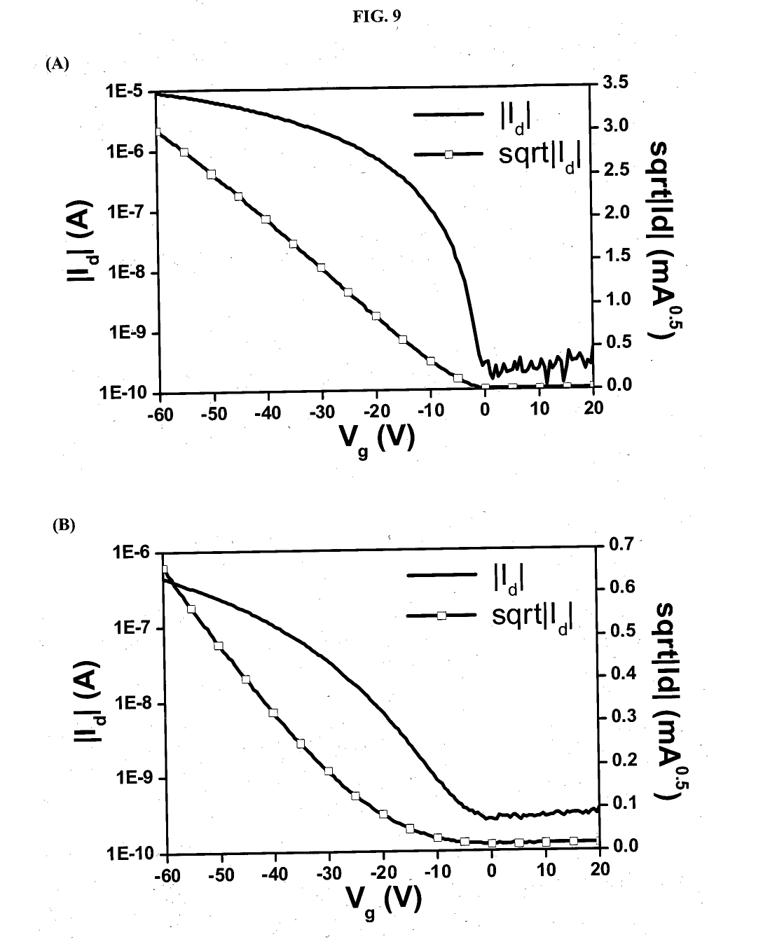

A N-alkyl diketopyrrolo-pyrrole (DPP) based p-type semiconductor, synthesized in IMRE was used in this study as an example of conjugated polymer. Details of the DPP polymer may be found in US patent application US2012/0161117A1. Structure of the DPP based p-type semiconductor is shown in FIG. 8.

The innovative ink was used to print source/drain electrodes to compare with pristine Ag source/drain electrodes in the same device configurations.

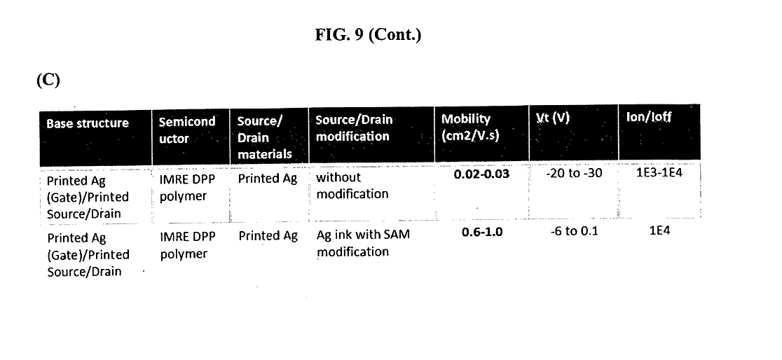

FIG. 9 depict graphs of measured I_{D}-V_{G} characteristics of PFETs based on the N-alkyl diketopyrrolo-pyrrole (DPP) semiconductor for (A) ink formulated electrodes and (B) pristine electrodes. FIGS. 9(A) and (B) illustrate OFET I_{d}V_{g} transfer characteristics, where (A) depicts transistor source/drain (S/D) printed using the modified Ag ink disclosed herein, and (B) depicts transistor S/D printed using pristine Ag ink. With reduced injection barrier or contact resistance between DDP and Ag source and drain, the transfer curve shown in FIG. 9(A) illustrated sharp switch-on at the lower gate voltage (V_{gs}), near zero threshold voltage Vₜₕ and high on current Iₒₙ. These are all desirable electric characteristics of a transistor. In contrast, the transfer curve displayed in FIG. 9(B) is much less desirable due to mismatch of Ag work function (about 4.7 eV) and DPP HOMO level (5.2 eV).

FIG. 9(C) is a table showing mobility (cm²/V·s), Vt (V) and Iₒₙ/I_{off} values for printed Ag (Gate)/printed source/drain structure using DPP polymer semiconductor, and printed Ag as source/drain material (i) without modification, and (ii) Ag ink with SAM modification. Results summarized in the table shows that the printed OFET devices using the innovative ink improved OFET mobility in two orders of magnitude, as compared to results generated from devices using pristine Ag ink.

Field effect mobility is an important parameter in measuring device performance of printed field effect transistors. It determines the current that may be delivered by a PFET at a given voltage bias. PFETs that are able to deliver high currents per voltage bias feature high gains and speed. Therefore, high device mobility is desired.

These results confirmed that the crucial effect on OFET performances with semiconductor structure and orientation, in this case it is edge-on π-π stacking, and the effectiveness of the modified Ag ink effect on self-assembly solution processed organic semiconductors (small molecular and polymer). This result further confirmed the versatility of this innovation and the importance of the innovation in printed electronics.

While the present invention has been particularly shown and described with reference to exemplary embodiments thereof, it will be understood by those of ordinary skill in the art that various changes in form and details may be made therein without departing from the spirit and scope of the present invention as defined by the following claims.

1-16. (canceled)

17. A method of preparing an electrically conductive ink composition, the method comprising:
a) providing one or more electrically conductive particles;
b) contacting each of the one or more electrically conductive particles with a surface modifying agent selected from the group consisting of tetracyanoquinodimethane, F4-tetracyanoquinodimethane, and mixtures thereof, and forming a layer of the surface modifying agent on each of the one or more electrically conductive particles by self-assembly.

18. The method according to claim 17, wherein the one or more electrically conductive particles comprises or consists of a metal.

19. The method according to claim 18, wherein the one or more electrically conductive particles comprises or consists of a metal selected from Group 3 to Group 13 of the Periodic Table of Elements, steel, or combinations thereof.

20. The method according to claim 17, wherein the one or more electrically conductive particles comprises or consists of a metal selected from the group consisting of silver, copper, gold, nickel, aluminum, or combinations thereof.

21. The method according to claim 17, wherein the one or more electrically conductive particles are nanoparticles.

22. The method according to claim 17, wherein the surface modifying agent is chemically bonded to a surface of each of the one or more electrically conductive particles.

23. The method according to claim 17, wherein at least a substantial portion of the surface area of each of the one or more electrically conductive particles that is exposed to the surface modifying agent is covered by the surface modifying agent.

24. An electrically conductive ink composition prepared by a method of preparing an electrically conductive ink composition, the method comprising:
a) providing one or more electrically conductive particles;
b) contacting each of the one or more electrically conductive particles with a surface modifying agent selected from the group consisting of tetracyanoquinodimethane, F4-tetracyanoquinodimethane, and mixtures thereof, and forming a layer of the surface modifying agent on each of the one or more electrically conductive particles by self-assembly.

25. An electrically conductive ink composition comprising one or more electrically conductive particles, wherein each of the one or more electrically conductive particles has a self-assembled layer of a surface modifying agent selected from the group consisting of tetracyanoquinodimethane, F4-tetracyanoquinodimethane, and mixtures thereof attached to its surface.

26. The electrically conductive ink composition according to claim 25, wherein the one or more electrically conductive particles comprise or consist of a metal.

27. The electrically conductive ink composition according to claim 25, wherein the one or more electrically conductive particles comprises or consists of a metal selected from Group 3 to Group 13 of the Periodic Table of Elements, steel, or combinations thereof.

28. The electrically conductive ink composition according to claim 25, wherein the one or more electrically conductive particles comprises or consists of a metal selected from the group consisting of silver, copper, gold, nickel, aluminum, or combinations thereof.

29. The electrically conductive ink composition according to claim 25, wherein the one or more electrically conductive particles are nanoparticles.

30. The electrically conductive ink composition according to claim 25, wherein the surface modifying agent is chemically bonded to a surface of the one or more electrically conductive particles.

31. The electrically conductive ink composition according to claim 25, wherein at least a substantial portion of the surface area of each of the one or more electrically conductive particles that is exposed to the surface modifying agent is covered by the surface modifying agent.
